(19) United States
(12) Patent Application Publication
(10) Pub. No.: US 2011/0016900 A1
(43) Pub. Date: Jan. 27, 2011

(54) COOLING SYSTEM FOR A MOTOR VEHICLE

(75) Inventors: Leo P. Oriet, Rochester Hills, MI (US); Andre Bocancea, Windsor (CA); Jules Cazabon, Staples (CA)

Correspondence Address: NAVISTAR CANADA, INC.;C/O Navistar, Inc., 4201 WINFIELD ROAD, P.O. BOX 1488, WARRENVILLE, IL, 60555, US

(73) Assignee: International Truck Intellectual Property Company, LLC, Warrenville, IL (US)

(21) Appl. No.: 12/509,976

(22) Filed: Jul. 27, 2009

(51) Int. Cl. B60H 1/32; B60J 1/20

(52) U.S. Cl. 62/241; 296/95.1; 165/44

(57) ABSTRACT

Embodiments disclosed herein relate to a cooling system for a motor vehicle. One embodiment comprises a visor apparatus that includes an exterior visor having an inner face, and an opposite outer face, and a heat exchanger attached to the inner face of the exterior visor. The heat exchanger has an inlet and an outlet. An exchange bed is in fluid communication with the inlet and the outlet. A cooling system circuit is located within the motor vehicle and is in fluid communication with the inlet and the outlet.

### BACKGROUND

Embodiments disclosed herein relate to a cooling system for a motor vehicle.

Motor vehicles have traditionally drawn cooling air or ram air from a location towards the front of a vehicle. The vehicle's movement along the road provides the force to drive air across cooling coils of the engine or other vehicle heat exchangers such as interior air conditioning or transmission oil coolers. Vehicle movement is required to achieve cooling without a fan. Fans directly engaged to the vehicle engine provide the force to move air across the cooling coils in low vehicle movement conditions. Typically a cooling system consists of a fan and heat exchangers and requires a steady source of quality air free of debris.

In a typical air conditioning system for a motor vehicle, three main components are mounted to different parts of the motor vehicle. A condenser is a heat exchanger mounted to the chassis under the hood at the front of the vehicle. A compressor is mounted to the engine block and draws power from the engine. The evaporator is a second heat exchanger mounted to the firewall located between the passenger compartment, such as a cab, and the engine compartment.

### SUMMARY

Embodiments disclosed herein relate to a cooling system for a motor vehicle. One embodiment comprises a visor apparatus that includes an exterior visor having an inner face, and an opposite outer face, and a heat exchanger attached to the inner face of the exterior visor. The heat exchanger has an inlet and an outlet. An exchange bed is in fluid communication with the inlet and the outlet. A cooling system circuit is located within the motor vehicle and is in fluid communication with the inlet and the outlet.

In another embodiment, a cooling system for a motor vehicle comprises a cab having a cab front, a cab back, and cab sides between the cab front and the cab back. A roof is located at a top of the cab and a windshield is located in the cab front. An A pillar is located between the windshield and the cab sides. A visor apparatus is mounted to the roof above the windshield and includes an exterior visor having an inner face, and an opposite outer face. A condenser is attached to the inner face of the exterior visor. The condenser has an inlet, an outlet, and an exchange bed in fluid communication with the inlet and the outlet. A compressor is in fluid communication with the inlet of the condenser. An evaporator is in fluid communication with the compressor.

### BRIEF DESCRIPTION OF THE DRAWINGS

FIG. 1 is a side view of a motor vehicle with a visor apparatus;

FIG. 2 is a top view of a motor vehicle with a visor apparatus;

FIG. 3 is an exploded view of a visor apparatus;

FIG. 4 is a bottom perspective view of a condenser block;

FIG. 5 is a schematic view showing a cooling system incorporating a visor apparatus with the arrows showing the direction of fluid flow;

FIG. 6 is a schematic view of a visor apparatus with any heat sinks and cover removed; and

FIG. 7 is a schematic view of a visor apparatus with any heat sinks and cover removed.

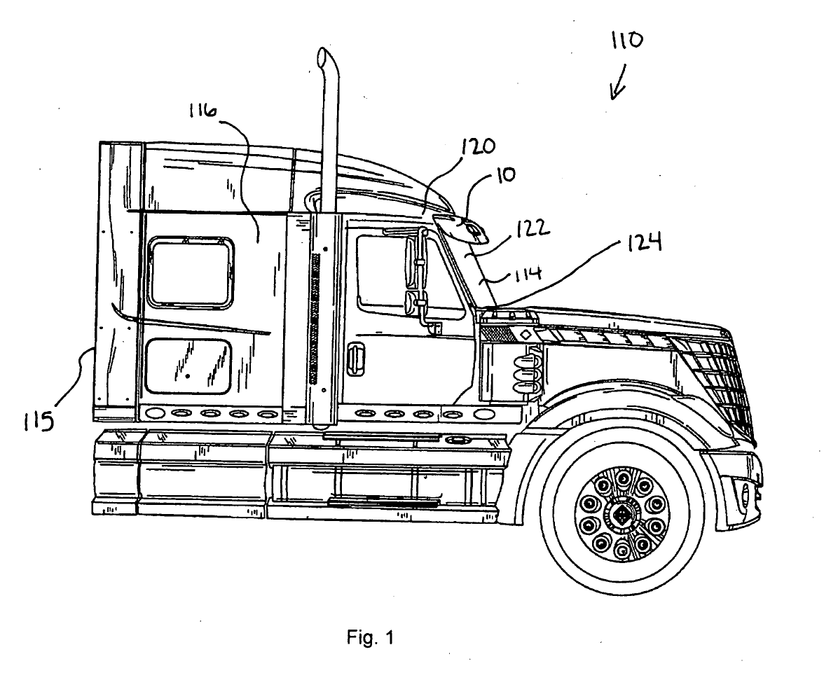

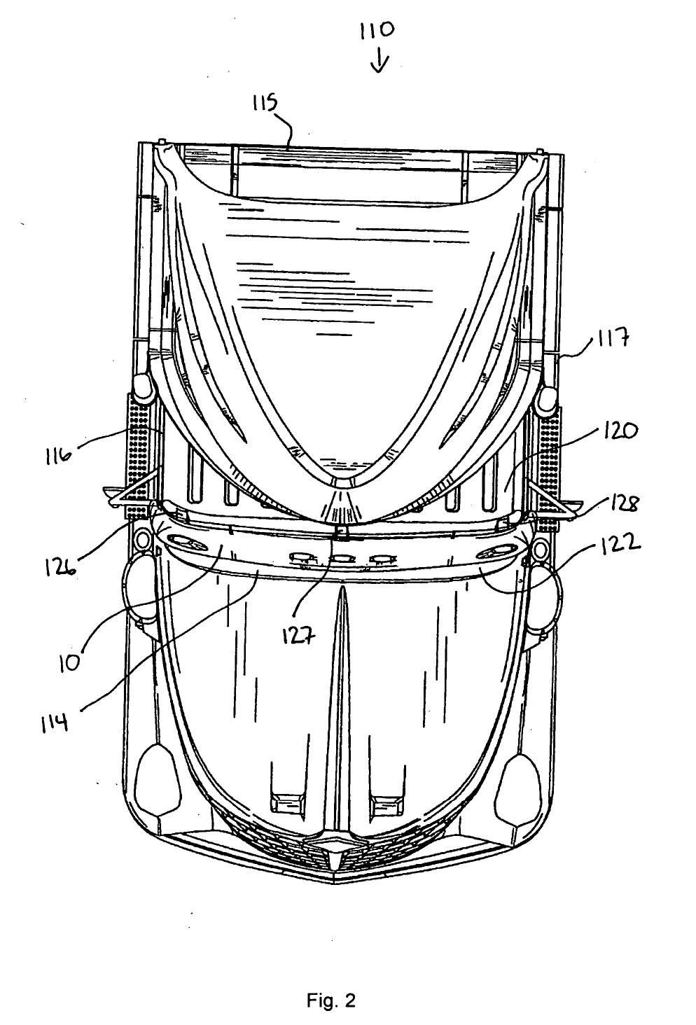

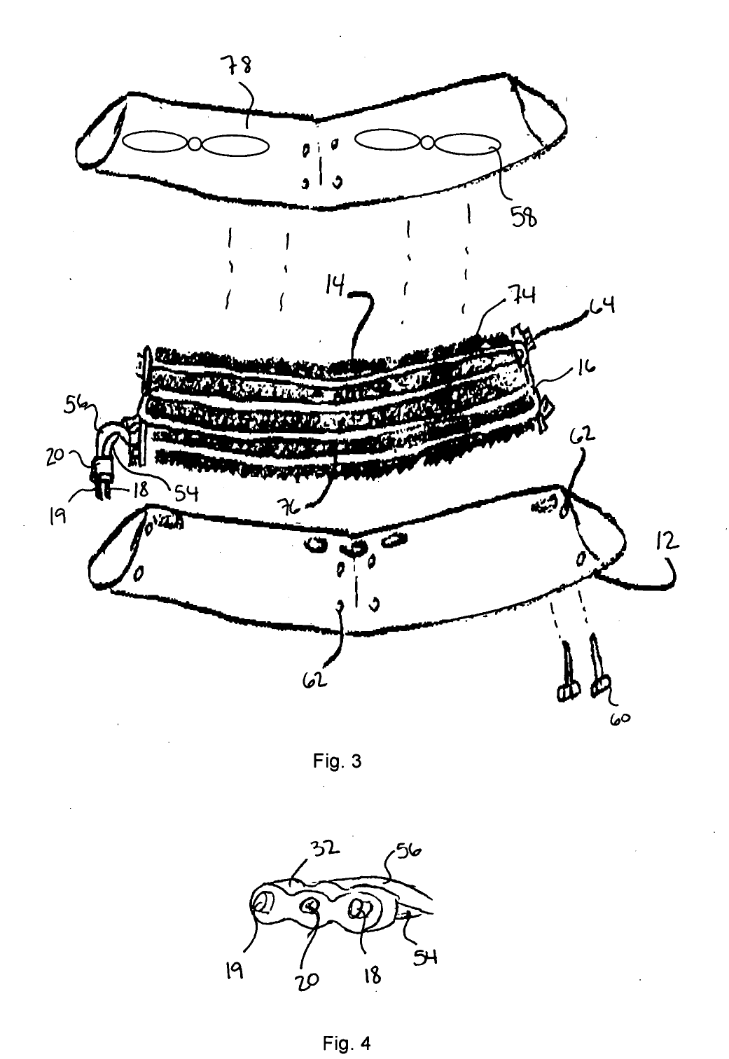

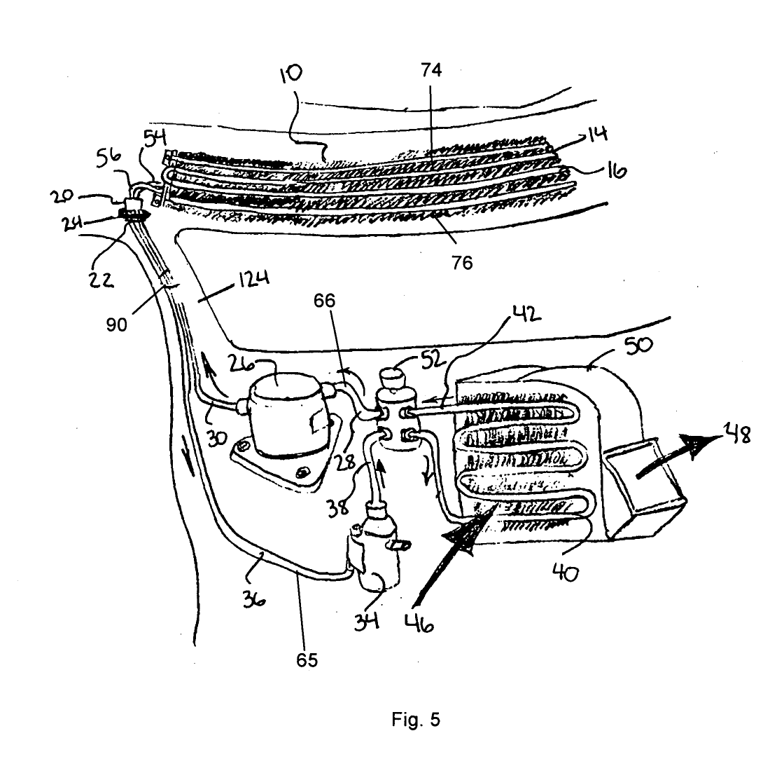

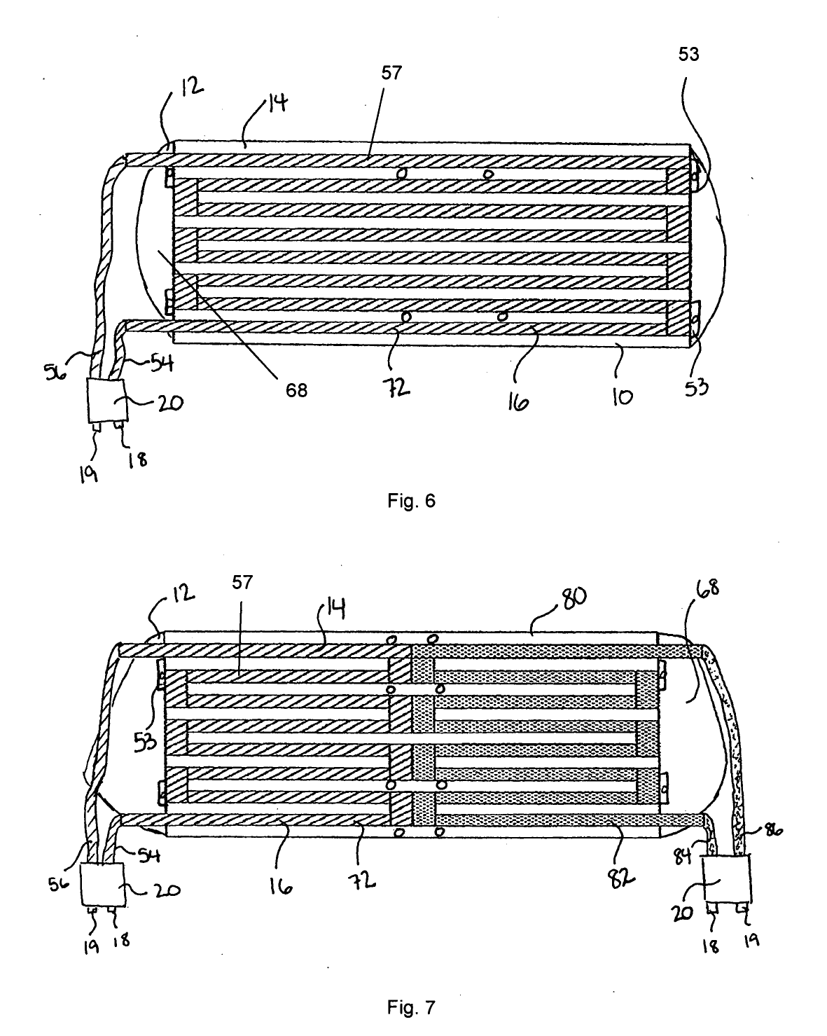

### DETAILED DESCRIPTION

Referring now to the Figures where like reference numerals refer to like structures, a motor vehicle 110 has a passenger compartment, such as a truck 111 with a cab 112 or a bus. Cab 112 has a cab front 114, a cab back 115 and cab sides 116, 117 between the cab front 114 and the cab back 115 to form a cab enclosure 118. A roof 120 is located at the top of the cab enclosure 118. A windshield 122 is located in the cab front 114. An A pillar 124 is located between the windshield 122 in the cab front 114 and each cab side 116, 117. One or more visor apparatus 10 mounts to the outside of the cab 112 at the roof above the windshield 122, such as to mounts 126, 127, 128.

The visor apparatus 10 has an exterior visor 12 and at least one heat exchanger 72. The exterior visor 12 has an inner face 68 and an opposite outer face 70. When the visor apparatus 10 is mounted to the motor vehicle, the heat exchanger 72 is in fluid communication with a heating, ventilation and air conditioning (HVAC) system, or used in a different system, such as a cooling system for the engine, oil or transmission. Heat exchanger 72 can be used as a primary component or as a secondary component of a cooling system, such as a secondary condenser, or a secondary heat exchanger for a heating system, an engine cooling system, an oil cooling system or a transmission cooling system. A cover 78 can cover the heat exchanger 72 opposite the exterior visor 12. A line bundle 90 connects the visor apparatus 10 to a cooling system circuit 66 of the cooling system 65.

The heat exchanger 72 attaches to the inner face 68 of the exterior visor 12. Fasteners 60 matingly engaging visor holes 62 in the inner face 68 and condenser bores 64 in the heat exchanger 72.

The heat exchanger 72 can be in fluid communication with a cooling system circuit, such as condenser 14 with an exchange bed 16 in fluid communication with a compressor 26 and an evaporator 40 in cooling system circuit 66, such as air conditioning system 65. The condenser 14 can have a frame 53 to which the exchange bed 16 attaches. The exchange bed 16 can include coils or tubing 57 located between an inlet 54 and outlet 56. The exchange bed 16 can have heat sinks 74, 76, such as thermally conductive material folded over on itself. The inlet 54 and outlet 56 is in fluid communication with the exchange bed 16. The bores 64 corresponding to visor holes 62 can be located in the frame 53. The inlet 54 and outlet 56 engage a connector block 20.

The connector block 20 can have an inlet connector 18 and an outlet connector 19 extending outwardly from the block body 32. The connector block 20 can have passages which the inlet connector 18 and the outlet connector 19 engage. The inlet connector 18 is in fluid communication with the inlet 54 and connects to the line bundle 90 such as a compressor outlet line 30. The line bundle 90 is in fluid communication with the compressor 26 and the evaporator 40. The outlet connector 19 is in fluid communication with the outlet 56 and connects to the line bundle 90. The connector block 20 can have a second inlet connector 18 engaging the inlet 54 and a second outlet connector 19 engaging the outlet 56. The connector block 20 attaches to the motor vehicle 110, such as the cab 112 at the A pillar 124 near or at the roof 122. A seal 24 closes an access opening 22 in the motor vehicle 110 to access to the compressor outlet line 30 and the dehydrator inlet line 36.

One or more fans 58 can circulate the air under the visor apparatus 10. The fan 58 can attach to the visor apparatus 10 such as to the frame 53, a cover 78 or the motor vehicle 110 at or near the roof 122.

The compressor 26 is in fluid communication with the condenser 14 in cooling system 65. The compressor 26 has compressor inlet and outlet lines 28, 30. The compressor outlet line 30 is in the cab 112, such as the A pillar 124, and attaches to the condenser block 20. The compressor inlet line 28 connects to an expansion valve 52. The compressor 26 has a motor and compressor, both of which can be within the same unit, such as a hermetically sealed compressor having an electric motor and compressor within the same housing. The compressor 26 can be double piston reciprocating, centrifugal or rotary types. The compressor 26 can be mounted to the engine block or to the cab 112, such as under the dashboard, to the firewall, under the roof, under a seat, and the like.

The dehydrator 34 is in fluid communication with the condenser 14. The dehydrator 34 has dehydrator inlet and outlet lines 36, 38. The dehydrator inlet line 36 is in the cab 112, such as the A pillar 124, and attaches to the condenser block 20. The dehydrator outlet line 38 attaches to the expansion valve 52.

An evaporator circuit 42 extends from the expansion valve 52 to the heat exchanger or evaporator 40 and back again to the expansion valve 52. Warm air 46 is cooled in the evaporator circuit 42. The evaporator 40 and the evaporator circuit 42 can be mounted to the cab 112, such as to the firewall, under the dashboard, under the roof 120, and the like. An evaporator blower 50 can engage the evaporator 40 to expel the cooled air 48 into the cab 112.

A visor apparatus 80 can have multiple heat exchangers 72, 82 attached to the exterior visor 12. The heat exchangers 72, 82 can be used for a primary cooling system, such as a condenser 14, or used as a secondary component of a cooling system, such as a secondary condenser, a heating system, an engine cooling system, an oil cooling system or a transmission cooling system. The heat exchangers 72, 82 can be used in different cooling systems, such as the heat exchanger 72 being used in a first air conditioning system and the other heat exchanger 82 being used in a second air conditioning system, a heating system, an engine cooling system, an oil cooling system or a transmission cooling system. Heat exchanger 82 has an inlet 84 and an outlet 86 in fluid communication with an exchange bed 88.

What is claimed is:

1. A cooling system for a motor vehicle, comprising:
a visor apparatus including an exterior visor having an inner face, and an opposite outer face, and a heat exchanger attached to the inner face of the exterior visor;
an inlet in the heat exchanger;
an outlet in the heat exchanger;
an exchange bed in fluid communication with the inlet and the outlet; and
a cooling system circuit located within the motor vehicle and being in fluid communication with the inlet and the outlet.

2. The cooling system for a motor vehicle of claim 1, further comprising:
a connector block having an inlet connector in fluid communication with the inlet, and an outlet connector in fluid communication with the outlet.

3. The cooling system for a motor vehicle of claim 2, wherein the cooling system circuit further comprises:
a line bundle located within the motor vehicle and connected to the inlet connector and the outlet connector of the connector block.

4. The cooling system for a motor vehicle of claim 2, further comprising:
an A pillar in the motor vehicle; and
a line bundle being located within the A pillar and connecting to the inlet connector and the outlet connector of the connector block.

5. The cooling system for a motor vehicle of claim 4 wherein the heat exchanger attaches to the exterior visor with a frame attached to the exchanger bed.

6. The cooling system for a motor vehicle of claim 5, wherein the heat exchanger is a condenser.

7. The cooling system for a motor vehicle of claim 5, further comprising:
a cover covering the heat exchanger opposite the exterior visor; and
a fan attached to the cover.

8. A cooling system for a motor vehicle, comprising:
a cab having a cab front, a cab back, and cab sides between the cab front and the cab back;
a roof at a top of the cab;
a windshield in the cab front;
an A pillar located between the windshield and the cab sides;
a visor apparatus being mounted to the roof above the windshield and including an exterior visor having an inner face, and an opposite outer face, and a condenser attached to the inner face of the exterior visor, the condenser having an inlet, an outlet, and an exchange bed being in fluid communication with the inlet and the outlet;
a compressor in fluid communication with the inlet of the condenser; and
an evaporator in fluid communication with the compressor.

9. The cooling system for a motor vehicle of claim 8, further comprising:
a connector block having an inlet connector in fluid communication with the inlet, and an outlet connector in fluid communication with the outlet.

10. The cooling system for a motor vehicle of claim 9, further comprising:
a line bundle located in the cab and connected to the inlet connector and the outlet connector of the connector block; and
wherein the line bundle is in fluid communication with the compressor and the evaporator.

11. The cooling system for a motor vehicle of claim 9, further comprising:
a line bundle located in the A pillar and connected to the inlet connector and the outlet connector of the connector block; and
wherein the line bundle is in fluid communication with the compressor and the evaporator.

12. The cooling system for a motor vehicle of claim 9, further comprising:
a compressor outlet line located in the cab and attached to the inlet connector of the condenser block.

13. The cooling system for a motor vehicle of claim 12, further comprising:
a dehydrator in fluid communication with the condenser and having a dehydrator inlet line located in the cab and attached to the outlet connector of the condenser block; and
an expansion valve in fluid communication with the evaporator, the compressor and the dehydrator.

14. The cooling system for a motor vehicle of claim 9, further comprising:
a compressor outlet line located in the A pillar and attached to the inlet connector of the condenser block.

15. The cooling system for a motor vehicle of claim 14, further comprising:
a dehydrator in fluid communication with the condenser and having a dehydrator inlet line located in the A pillar and attached to the outlet connector of the condenser block; and
an expansion valve in fluid communication with the evaporator, the compressor and the dehydrator.

16. The cooling system for a motor vehicle of claim 15, wherein the heat exchanger is attached to the exterior visor with a frame attached to the exchanger bed.

17. The cooling system for a motor vehicle of claim 16, further comprising:
a cover covering the heat exchanger opposite the exterior visor; and
a fan attached to the cover.
